(19) United States
(12) Patent Application Publication
(10) Pub. No.: US 2023/0363573 A1
(43) Pub. Date: Nov. 16, 2023

(54) COLLECTOR OF BEVERAGE MACHINE WITH WASTE MANAGEMENT

(71) Applicant: SOCIETE DES PRODUITS NESTLE S.A., Vevey (CH)

(72) Inventors: YAN DUPASQUIER, Romont (CH); GILLES GAVILLET, Ursy (CH); RENZO MOSER, Gummenen (CH)

(21) Appl. No.: 18/246,346

(22) PCT Filed: Sep. 22, 2021
(86) PCT No.: PCT/EP2021/075989

§ 371 Date: Mar. 23, 2023

(30) Foreign Application Priority Data
Sep. 24, 2020 (EP) 20197942.4

(51) Int. Cl. A47J 31/36; A47J 31/40

(52) U.S. Cl. CPC A47J 31/3619; A47J 31/3638; A47J 31/40

(57) ABSTRACT

A machine (1) for preparing a beverage (7) has: a waste collector (85) with a horizontally extending collecting area (85′″); and a removal arrangement (20, 22, 86, C) configured to direct, after beverage preparation, a waste consumable (2″), such as a used flavouring ingredient, into the waste collector (85). Successive waste consumables (2″) are directed to different horizontal locations (21a′, 21b′, 21c′) of the collecting area (85′″).

### FIELD OF THE INVENTION

The field of the invention pertains to beverage preparation and serving machines which typically use thermally conditioned liquid, such as heated and/or cooled liquid. The liquid is typically water or water-based. The liquid may be a carrier and/or a solvent for preparing the beverage. The machine may be configured to prepare the beverage by mixing the liquid with a flavouring ingredient, e.g. a flavouring ingredient supplied in a solid form, of the beverage to be prepared.

The machine may be configured to handle a portioned flavouring ingredient. Therefore, typically a predetermined amount of consumable is preconditioned (e.g. factory preconditioned) prior to introduction into the machine. One or a plurality of such preconditioned amounts of consumable are used for producing a single beverage serving by such machine.

The portioned flavouring ingredient may be supplied within a capsule into the machine or without such capsule. A “capsule” is meant to include any container such as a packaging for containing the portioned beverage ingredient, the packaging forming an enclosure of any material, in particular an airtight or pervious material, porous or non-porous material, e.g. paper, plastic, aluminium, recyclable and/or biodegradable packagings, and of any shape and structure, including soft pods or rigid cartridges for containing the ingredient.

For the purpose of the present description, a “beverage” is meant to include any human-consumable liquid substance, such as tea, coffee, cacao, hot or cold chocolate, milk, soup, baby food, etc.

### BACKGROUND ART

Certain beverage preparation machines use capsules containing ingredients to be extracted or to be dissolved and/or ingredients that are stored and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

EP2175762 discloses a brewing unit that includes on a support structure a seat with a rotation movement and a piston sliding in the seat as well as a counter-piston, which are movable between a loading configuration. Several brewing configurations for delimiting different brewing chamber volumes and an ejection configuration are disclosed.

EP3253263 relates to a brewing unit for brewing bulk ground coffee that has an infusion chamber cooperating with a closing piston and with an ejection piston. For ejecting the ground coffee after its extraction with hot water, the ejection piston is moved against the closing piston to squeeze the extracted ground coffee prior to ejecting the cake.

WO 2009/074559, WO 2009/135869 and WO2019/158542 disclose different arrangements for managing waste consumables in a waste collector of a beverage preparation machine.

### SUMMARY OF THE INVENTION

The invention relates to a machine for preparing a beverage from at least one ingredient. Normally such beverage is then dispensed to a user, e.g. to a user-cup or user-mug.

The beverage preparation typically includes the mixing of a plurality of beverage ingredients. For instance, the mixing may involve an infusion of a beverage ingredient, such as an infusion of ground coffee or tea with water.

A predetermined amount of beverage can be formed and dispensed on user-request, which corresponds to a serving. The volume of such a serving may be in the range of 15 to 1000 ml such as 25 to 600 ml for instance 40 to 250 ml, e.g. the volume for filling a cup or mug, depending on the type of beverage. Formed and dispensed beverages may be selected from ristrettos, espressos, lungos, cappuccinos, café latte, americano coffees, teas, etc. . . . . For example, a coffee machine may be configured for dispensing espressos, e.g. an adjustable volume of 20 to 60 ml per serving, and/or for dispensing lungos, e.g. a volume in the range of 60 to 200 ml per serving, and/or for dispensing americanos, e.g. a volume in the range of 150 to 750 ml.

The machine of the invention is configured for handling a flavouring ingredient and preparing a beverage therefrom and serving such beverage via a dispensing outlet to a consumer receptacle, e.g. placed on a support. The beverage may be selected from coffee and tea and cacao. The beverage may be prepared by mixing the flavouring ingredient with water from a water source e.g. a water tank and/or a connector to a water distribution network, for instance via a liquid driver such as a pump and/or via a thermal conditioner e.g. a water heater and/or a cooler.

The thermal conditioner may have a thermal power in the range of 300 to 3000 watt, for instance of 500 to 2300 watt, such as of 700 to 1800 watt, e.g. of 950 to 1500 watt.

The machine has a mixing unit that comprises a support, such as a frame and/or housing, that is stationary during the handling of the flavouring ingredient and optionally during beverage preparation and/or beverage serving.

The mixing unit includes a seat, such as a seat delimiting a substantially prismatic or cylindrical inner shape having a base that is for instance substantially circular or elliptic or ovoidal or polygonal. The seat has an ingredient opening. The flavouring ingredient may be received within or without capsule via the ingredient opening.

The flavouring ingredient supplied into the ingredient opening may be in the shape of at least one solid portion of a self-supporting agglomerate of such flavouring ingredient, such as one solid portion or a discrete number of solid portions, e.g. 2 or 3 or 4 or 5 or 6 portions.

The flavouring ingredient may be supplied within a capsule or without such capsule into the machine. The ingredient may be supplied within the capsule into the machine and then separated from the capsule prior to mixing the flavouring ingredient with water, for example prior to its introduction into the ingredient opening. Examples of flavouring ingredients that can be removed from a capsule by the machine prior to mixing with water are disclosed in WO2019/219523 and EP2019217270.8.

The solid portion can have a rollable shape, e.g. a substantially spherical or ellipsoidal or cylindrical shape or a combination of parts of such shapes, with: a maximum dimension in the range of 15 to 35 mm such as 17.5 to 30 mm e.g. 20 to 27 mm; and/or a maximum dimension in the range of 10 to 90%, for instance 25 to 75% such as 40 to 65% e.g. 51 to 60%, of a maximum dimension of the base of the seat's inner shape.

The flavouring ingredient forming the solid portion can be for instance selected from ground coffee and tea and cacao, such as 4 to 12 g ground coffee e.g. 5 to 9 g ground coffee.

The solid portion may be configured to resist a compression force of at least 20 N such as at least 30, e.g. at least 40 N.

The solid portion may be configured to be crushed under a compression force of at most 150 N, for instance at most 135 N, such as at most 120 N, e.g. at most 115 N.

Such compression force necessary and sufficient for crushing the solid portion can be measured when the solid portion is squeezed between two parallel plates with the compression force applied to the plates.

The mixing unit has a closure part, for instance fixed to or integral with the seat or configured to close and open the ingredient opening of the seat. The closure part may be configured to form a lid on the opening.

Further possible implementation details of such a closure part cooperating with the seat, e.g. a sealing thereof, are disclosed for example in EP2020187603 and EP2020187613.

The mixing unit includes a wall part that is movable relative to the seat, such as movable inside the seat.

For instance, the wall part is formed by a piston.

The wall part may be movable by a wall part actuator, e.g. a motor. The actuator may be connected to the control unit discussed below and controlled thereby.

The wall part can be dimensioned to be in sliding contact along and over inner boundaries of the inner shape of the seat at a seal that is stationary relative to the wall part and that seals the wall part against the inner shape.

Further possible implementation details of such a wall part cooperating with the seat, e.g. relative movements and/or actuations thereof, are disclosed for example in EP2020187598.

The mixing unit includes a waste collector, for instance a waste reservoir that is user-removable for emptying and/or servicing e.g. cleaning. The collector delimits a collecting chamber extending upright over a collecting height and horizontally over a collecting area. The collecting height may correspond to a distance in the range of 75 to 125%, e.g. 85 to 115% such as 95 to 105% of a vertical spacing between a bottom of the collecting chamber and a top end of the waste collector (in an orientation of the machine for the abovementioned serving of the beverage).

The collector may be associated with a detector for detecting a level of waste in the collector chamber that has reached the collecting height. The detector maybe mechanical and/or optical and/or capacitive. The detector can be configured for preventing further preparation of beverage until the collector has been emptied and/or for activating an alarm signal that is user-perceivable, e.g. visible and/or acoustic. The detector may be connected to the control unit discussed below.

The seat, the closure part and the wall part are directly or indirectly mounted to the support, e.g. the wall part being carried by the seat and/or the wall part actuator (when present) being directly or indirectly fixed to the seat.

The seat, the closure part and the wall part are relatively movable between:
at least one transfer configuration for: supplying the flavouring ingredient with or without an ingredient capsule into the seat; and/or removing upon beverage preparation a waste consumable formed by waste flavouring ingredient and/or an ingredient capsule, for instance an unwrapped block of waste ingredient e.g. a cake; and
a mixing chamber configuration in which the seat and the closure part and the wall part form a mixing chamber fluidically connected with the water source.

Further possible implementation details of such a closure part, wall part cooperating with the seat, e.g. relative movements and/or actuations thereof, are disclosed for example in EP2020187594 and EP2020187599.

The mixing unit is configured such that, during beverage preparation, the flavouring ingredient is mixed with the water in the mixing chamber to form the beverage, e.g. by infusion and/or dissolution and/or dispersion, prior to serving thereof via the dispensing outlet.

The mixing unit includes a removal arrangement configured to direct, e.g. to push, after mixing, the abovementioned waste consumable into the waste collector.

The waste consumable may be a used ingredient capsule that has been substantially or entirely emptied during the beverage preparation, the flavouring ingredient being for instance an ingredient dissolvable and/or dispersible with the water during mixing, e.g. liquid milk or powder milk or powder chocolate or liquid chocolate or concentrate or powder soup or instant coffee or instant tea or instant cacao.

The waste consumable may be a used ingredient capsule that contains residual flavouring ingredient, such as an infused ingredient, e.g. ground coffee or tea leaves or ground cacao.

The waste consumable can be a capsule-free residual flavouring ingredient, such as an infused ingredient, e.g. ground coffee or tea leaves or ground cacao, for instance a cake of the residual ingredient.

The mixing chamber may be associated with a thermal conditioner, e.g. a heater and/or cooler, for thermally (pre-)conditioning the mixing chamber prior to mixing, typically when no water is supplied into the mixing chamber. The conditioner can be connected to the control unit discussed below and controlled thereby. Further possible implementation details of such a thermal conditioning are disclosed for example in EP2020187621.

The seat may be moved relatively to the support by a seat actuator, such as a motor, that is fixed to the support or to the seat. The actuator may be connected to the control unit discussed below and controlled thereby.

The seat actuator can relatively move the support and the seat via a transmission. Such transmission may include at least one of: gears, for instance wheels, e.g. toothed wheels, and/or worms; levers e.g. levers connected by a knuckle joint; belts such as toothed belts; and racks such as toothed racks.

The seat actuator may be different to the wall part actuator and/or different to a remover actuator (e.g. as discussed below). Likewise, the remover actuator may be connected to the control unit discussed below and controlled thereby.

The closure part may be fixed relative to the support and the seat may be movable: against the closure part so as to close the ingredient opening by the closure part; and away from the closure part so as to open the ingredient opening.

The closure part can be configured to cover a rim of the ingredient opening and/or to remain substantially outside the seat, when the seat is closed by the closure part. The closure part and the seat can be sealed off by a seal.

The wall part and/or the abovementioned wall part actuator (when present) can be mounted to follow movements of the seat.

The waste consumable may be moved by the wall part out of the mixing chamber e.g. via the ingredient opening.

The ingredient opening may be tilted, e.g. (if not initially tilted) by relatively moving the seat and the closure part and the wall part from the mixing chamber configuration to the transfer configuration, to facilitate evacuation of the waste consumable. The ingredient opening may be tilted relative to a horizontal direction by an angle in the range of 5 to 80 deg., such as of 15 to 75 deg., for instance of 30 to 60 deg., e.g. of 40 to 50 deg.

A control unit may be provided, such as a unit comprising at least one of a controller, processor, printed circuit board, memory, user-interface and power manager. The control unit may be completely incorporated into the machine or may be at least partly deported into a distant device via a communication channel, e.g. a wired and/or wireless network, for instance including one or more of computers and mobile devices, e.g. smart phones or tablets. The control unit may be used for carrying out user-requested processes (e.g. beverage preparation and dispensing) and/or service processes (e.g. cleaning and/or rinsing processes and/or maintenance processes and/or management of flavouring ingredient and/or water and/or the management of the waste consumable).

The mixing chamber may be associated with an inlet guide and an outlet guide, such as an inlet guide located in the closure part and an outlet guide located in the wall part or vice versa or both inlet and outlet guides located in the closure part or in the wall part.

The outlet guide can be made of a flexible and/or rigid guide and/or associated with a filter.

The inlet guide may be associated with a water distributor e.g. a water shower.

The removal arrangement and the waste collector are configured so as to direct successive removals of such waste consumables to different horizontal locations of the collecting area.

Thus, by appropriately directing the waste consumables, a substantially uniform filling over the collecting area up to the collecting height of the collecting chamber may be promoted. In particular, filling-gaps in the collecting chamber that typically result from directing the waste consumables systematically towards the same location of the collecting chamber (e.g. forming a generally pyramidally, conically and/or domically shaped accumulation of waste consumables adjacent unoccupied accumulation space in the collecting chamber), can be avoided.

Uniform filling does not necessarily mean that the filling of waste consumable is compact in the collecting chamber. Rather, the level of fill by the waste consumable in the chamber can be substantially uniform over the chamber's collecting area. Empty space may remain between two different waste consumables in the collecting chamber.

Waste consumables may not be strictly aligned over the entire chamber's collecting area at the level of fill. Advantageously, however, the level of fill of the collecting chamber by the waste consumables is contained within a vertical range having a span corresponding to the maximum dimension (width, height or length, as the case may be) of a waste consumable, e.g. a used ingredient cake or a used ingredient capsule.

Typically, the removal arrangement and the waste collector are configured such as to promote a substantially uniform filling of the collecting chamber over its collecting height by the waste consumables of the successive removals. For instance, the removal arrangement and the waste collector are configured to form an accumulation of the waste consumables of the successive removals in the collecting chamber to reach the collecting height such that a ratio of residual collecting volume free of waste consumable between the accumulation and the collecting height over a total collecting volume of the collecting chamber is below 20%, for instance below 15%, for example below 10%, e.g. below 5%, of the total collecting volume of the collecting chamber.

The mixing unit may include a waste remover configured to remove the waste consumable from the ingredient opening upon beverage preparation and optionally after waste consumable having been pushed out of the opening by a corresponding relative movement of the wall part and the seat.

The ingredient opening can be associated with a waste remover configured to remove in a removal direction the waste consumable from opening towards the waste collector.

The ingredient opening can be associated with the remover, such as a pusher, that is configured to remove in a removal direction the flavouring ingredient from the ingredient opening towards the waste collector. The remover may be actuated by a or the abovementioned remover actuator.

The remover actuator, e.g. a motor, may be configured to relatively move the remover and the seat during removal of the waste consumable.

Details of a suitable configuration of the seat, the closure wall and the wall part with the remover as well as the operation thereof are disclosed, for example, in EP2020187609.

The remover can have a drawer-type configuration for being deployed and retracted over the ingredient opening in the transfer configuration.

The remover actuator may be connected to at least one of the remover and the seat by a transmission. Such transmission may include at least one of: gears, for instance wheels, e.g. toothed wheels, and/or worms; and racks e.g. toothed racks.

The remover actuator can be fixed to the support or to the seat. For instance, the remover actuator is different to the seat actuator and/or different to the wall part actuator.

Details of a suitable configuration of the seat, the closure wall and the wall part with the remover as well as the operation thereof are disclosed, for example, in EP2020187609.

The waste remover may be configured to direct such waste consumables to the collecting area at different velocities, for instance at a number of different velocities in the range of 2 to 10, such as 3 to 5. Thereby, it is possible to reach different points in the collecting chamber with the waste consumable depending on the velocity. The different velocities may be controlled by the remover actuator.

The removal arrangement may include a removal edge, such as a removal edge located above the collecting chamber and/or formed by the seat, from which the waste consumables are directed to the collecting chamber. The removal edge and the collecting chamber may be relatively movable, for instance horizontally and/or vertically, to direct the waste consumables to the different horizontal locations of the collecting area.

During the removal, different setups can be used as set out hereafter. The collecting chamber can be stationary and the removal edge can be movable relative to the support. The collecting chamber may be movable and the removal edge may being stationary relative to the support. The collecting chamber and the removal edge can be movable relative to each other and both movable relative to the support.

The removal arrangement may include a collector actuator configured to move back and forth, e.g. repeatedly back and forth, the waste collector relative to the support, for instance to vibrate the waste collector. The collector actuator may be activated permanently, periodically or intermittently, e.g. each time upon reception of such waste consumable by the collector. The collector actuator may be connected to and controlled by the abovementioned control unit.

The mixing unit can be configured to provide compressed gas, such as air, in the mixing chamber containing the waste consumable, e.g. comprising infusible flavouring ingredient upon infusion, after the serving of the beverage and to evacuate at least part of the water (possibly together with residual flavouring ingredient components) contained in the mixing chamber with the compressed gas by releasing the gas from the mixing chamber before the removal of the waste consumable.

Thereby, the waste consumable may be at least partied dried prior to removal of the waste consumable from the mixing chamber.

Details of a suitable drying with compressed gas are disclosed, for example, in EP2020193195.

Residues in the mixing chamber or downstream thereof may be largely avoided and cross-contamination between beverage servings may be reduced or even substantially suppressed. Providing a short downstream line from the mixing chamber to the beverage outlet may further reduce the risk of cross-contamination.

The mixing unit may be configured to repeat once or several times the providing of compressed gas into the mixing chamber and evacuating of part of the water with such compressed gas from the mixing chamber.

The mixing unit can be configured to inhibit or prevent an urging of the waste consumable against both the closure part and the wall part between the providing of the compressed gas into and its release from the mixing chamber. This can be useful to avoid unnecessary dispersion of water and ingredient residues in the system especially inside the mixing chamber by limiting physical contact between chamber parts, e.g. the closure part, and the waste consumable prior to (at least partly) drying thereof.

The mixing unit may be configured to inhibit or prevent a removal of the water contained in the mixing chamber from the waste consumable between the providing of the compressed gas into and its release from the mixing chamber. Typically, the mixing chamber can be sealed during the provision of the compressed gas for reasons of efficiency.

The dispensing outlet can be associated with a directing device configured to direct the beverage from the outlet guide to the consumer receptacle and residual liquid to the waste collector, e.g. via a draining edge of the directing device. For instance, the directing device is configured to direct at least part of the water evacuated from the mixing chamber by releasing the compressed gas to the waste collector or to the consumer receptacle.

The mixing unit may be configured to release the compressed gas via the abovementioned outlet guide so as to evacuate residual beverage from the outlet guide. For instance, the outlet guide is fluidically connected with an outlet valve for closing and opening the outlet guide, e.g. a solenoid valve and/or a pinch valve. The outlet valve can be closed when the compressed gas is contained in the mixing chamber and opened to release, via the outlet guide, the compressed gas with at least part of the water contained in the mixing chamber.

The mixing unit can be configured such that after releasing the compressed gas the wall part is moved against the waste consumable in the mixing chamber so as to compact the waste consumable in the mixing chamber, optionally without further evacuating part of the water possibly still contained in the mixing chamber. For instance, the waste consumable is compacted in the mixing chamber: between and against both the closure part and the wall part; and/or to undergo a volume reduction in the range of 5 to 75% such as 10 to 50%, e.g. 2 to 40%.

Thus, residual water in the mixing chamber may be used to assist clumping of waste consumable, e.g. residual flavouring ingredient, possibly still present in the mixing chamber and be removed with the waste consumable. Residual water possibly containing ingredient extracts can be inhibited from being disseminated after the gas release out of the waste consumable and into any liquid guide downstream the chamber, whereby cross-contamination between successive beverage preparations and dispensing can be inhibited and possibly even prevented.

The mixing unit may include a gas device for providing the compressed gas into the mixing chamber. Such device can have at least one of: a gas pump; a compressed gas tank; and a or the abovementioned valve used as a gas valve.

The device may incorporate the gas pump that is fluidically connected to the mixing chamber via a dedicated inlet of the mixing chamber or via the inlet guide and/or the outlet guide. For instance, the gas pump is controlled by a or the abovementioned control unit.

The device can include a compressed gas tank that is fluidically connected through a or the abovementioned gas valve to the mixing chamber via a dedicated inlet of the mixing chamber or via the inlet guide and/or the outlet guide. For instance, the gas valve is controlled by a or the abovementioned control unit.

The gas device may include the gas valve that fluidically connects the mixing chamber and a gas source, such as ambient air e.g. at ambient pressure (typically at about 1 bar), via a dedicated inlet of the mixing chamber or via the inlet guide and/or the outlet guide. The gas device may further include the wall part that is movable inside the seat. The gas valve and the wall part may be controlled by a or the abovementioned control unit. The wall part may be movable inside the seat to: expand the mixing chamber thereby drawing gas via the open gas valve into the mixing chamber; and collapse the mixing chamber thereby compressing the gas in the mixing chamber when the gas valve is closed.

The mixing unit can be configured to provide the compressed gas in the mixing chamber at a maximum pressure above ambient pressure of 0.5 bar, such as in the range of 1 to 30 bar, for instance 2 to 20 bar, e.g. 3 to 10 bar, for example 4 to 7 bar, above ambient pressure.

The mixing unit may be configured to release the compressed gas from the mixing chamber to evacuate at least part of the water from a or the abovementioned maximum pressure of the gas in the mixing chamber to a pressure of 0.1 bar above ambient pressure within a period of time of less than 3 sec., such as in the range of 0.001 to 2 sec., for instance in the range of 0.01 to 1 sec., for example in the range of 0.1 to 0.5 sec., e.g. in the range of 0.2 to 0.3 sec.

The abovementioned control unit can be configured to control a preconditioning of the flavouring ingredient after an introduction into the seat's ingredient opening in the transfer configuration of at least one solid portion of a self-supporting agglomerate of the abovementioned flavouring ingredient, such as (a) capsule-free portion(s) or (a) portion(s) within (a) capsule(s) removed by such machine prior to a passage of the portion(s) through the ingredient opening, and subsequent relative movement from the transfer configuration into the mixing chamber configuration and prior to serving the beverage via the dispensing outlet.

One or more solid portions may be introduced into the ingredient opening prior to the preconditioning, each portion having a rollable shape, e.g. a substantially spherical or ellipsoidal or cylindrical shape or a combination of parts of such shapes, with: a maximum dimension in the range of 15 to 35 mm such as 17.5 to 30 mm e.g. 20 to 27 mm; and/or a maximum dimension in the range of 10 to 90%, for instance 25 to 75% such as 40 to 65% e.g. 51 to 60%, of a maximum dimension of the abovementioned base of the seat's inner shape.

The preconditioning of the flavouring ingredient may include: a portion break-up relative movement of the seat and the closure part and the wall part, such as by controlling the abovementioned or one or more actuators, e.g. motors, associated therewith; and/or a portion loosening supply of water from a or the abovementioned water source into the mixing chamber, such as by controlling a or the abovementioned liquid driver and optionally a or the abovementioned thermal conditioner.

The control unit can be configured to control via the abovementioned at least one actuator the abovementioned break-up relative movement between the wall part and the closure part so as to exercise a compression force onto the solid portion(s) between the closure and wall parts to break-up the solid portion(s).

The agglomerate flavouring ingredient can be selected from ground coffee and tea and cacao, such as 4 to 12 g ground coffee e.g. 5 to 9 g ground coffee.

The control unit and the abovementioned at least one actuator may be configured such that the compression force is of at least 20 N, such as at least 30 N, for instance at least 40 N, optionally the compression force being of at most 200 N, such as at most 175 N, for instance at most 150 N, e.g. at most 125 N.

The control unit can be configured to control the break-up relative movement between the wall part and the closure part such that the closure and wall parts are relatively moved to one another between a break-up starting spacing at which the compression force is generated and a mixing spacing at which the abovementioned flavouring ingredient is mixed with the abovementioned water, whereby the mixing spacing and the break-up starting spacing have a ratio in the range of 0.1 to 0.8 such as 0.2 to 0.4.

Further possible implementation details of such a preconditioning are disclosed for example in EP2020187623.

The control unit, to control the preconditioning of the flavouring ingredient, may control the abovementioned liquid driver and optionally the abovementioned thermal conditioner e.g. for thermal conditioning to a temperature corresponding substantially to a water temperature during beverage preparation and serving of the beverage via the dispensing outlet, to supply the abovementioned portion loosening supply of water into the mixing chamber and then to interrupt the supply of water for a period of time, such as for 1 to 120 sec. for instance 5 to 60 sec. e.g. 10 to 30 sec. and/or at a pressure in the chamber that is substantially constant, prior to serving the beverage.

The control unit can be configured to control the supply into the mixing chamber of the abovementioned portion loosening supply of water:
after and/or before carrying out said portion break-up relative movement of the seat and the closure part and the wall part; and/or
in a volume that is in a range of 3 to 85%, such as 5 to 50%, e.g. 10 to 25%, of a total volume of the mixing chamber at a spacing of the closure and wall parts when the beverage is prepared and served via the dispensing outlet; and/or
at a or the abovementioned pressure in the mixing chamber that is in a range of 0.1 to 30 bar above ambient pressure, such as 0.5 to 25 bar above ambient pressure, for instance 1 to 20 bar above ambient pressure, e.g. 2.5 to 16 bar or 4 to 13 bar above ambient pressure; and/or
while closing the outlet guide with a or the abovementioned outlet valve, such as: a resilient valve, e.g. a check-valve; and/or a valve controlled by the control unit, e.g. a solenoid valve and/or a pinch valve.

Further possible implementation details of such a preconditioning are disclosed for example in EP2020187592.

The mixing chamber may be in fluid communication with a valve, such as at least one of the abovementioned valves, configured, e.g. controlled by a or the abovementioned control unit, to release pressure from the mixing chamber when containing the flavouring ingredient prior to driving the water into the mixing chamber for infusing the flavouring ingredient. Such valve may be assembled to or integral with the seat, the closure part, the wall part, the abovementioned inlet guide or the abovementioned outlet guide. The valve can be arranged to be open to release air from the chamber when the wall part and the closure part are relatively moved together. The valve may be arranged to be closed from a beginning of introduction of the water into the mixing chamber containing the flavouring ingredient to form the beverage and until serving thereof, for instance until completion of serving thereof. Using such a valve configuration can be beneficial when the volume of the mixing chamber is reduced due to a relative movement of the closure part and the wall part towards each other, especially when the mixing chamber is otherwise sealed off prior to infusion. Further possible implementation details of such a valve arrangement are disclosed for example in EP2020187612.

The invention also relates to a combination of a machine as described above and the abovementioned flavouring ingredient for preparing the beverage in the machine.

Another aspect of the invention relates to a method of handling a flavouring ingredient and preparing a beverage therefrom and serving the beverage via a dispensing outlet to a consumer receptacle. The method includes: providing a machine as described above; supplying the flavouring ingredient into the seat in the transfer configuration; in the mixing chamber configuration, mixing the ingredient with the water in the mixing chamber to form the beverage; serving the beverage via the dispensing outlet; and removing the waste consumable by the removal arrangement to the waste collector, whereby waste consumables of successive removals are directed to different horizontal locations of the collecting area.

A further aspect of the invention relates to a use of an ingredient as a flavouring ingredient: as a supply to a machine as described above; for an implementation of a combination as described above; or for an execution of a method as described above.

### BRIEF DESCRIPTION OF THE DRAWINGS

The invention will now be described with reference to the schematic drawings, wherein:

FIG. 1 is a schematic view of a machine according to the invention;

FIG. 2a schematically shows the mixing unit of FIG. 1 while dispensing the beverage;

FIG. 2b illustrates the mixing unit of FIG. 1 when the dispensing of the beverage is ended, before at least partly drying a wet flavouring ingredient in the unit's mixing chamber after the ingredient has been mixed with water to prepare the beverage;

FIG. 2c illustrates an introduction of gas into the mixing chamber after the end of the beverage dispensing;

FIG. 2d shows the sealing of the mixing chamber after the introduction of gas thereinto;

FIG. 2e shows a compression of the gas in the mixing chamber;

FIG. 2f illustrates a release of the gas and evacuation of water, possibly beverage residues, from the mixing chamber;

FIG. 2g shows a compacting of the waste consumable comprising the used flavouring ingredient in the mixing chamber after the release of the gas and the evacuation of water;

FIG. 2h illustrates the wall part moving the waste consumable out of the mixing chamber;

FIG. 2i shows a remover for removing the waste consumable from the ingredient opening;

FIG. 3 shows the removal of the waste consumable to the waste collector along different possible paths to different horizontal locations of the collector's collecting area; and

FIG. 4 illustrates a comparative removal of the waste consumable to the waste collector along a single possible path to a single horizontal location of the collector's collecting area.

### DETAILED DESCRIPTION

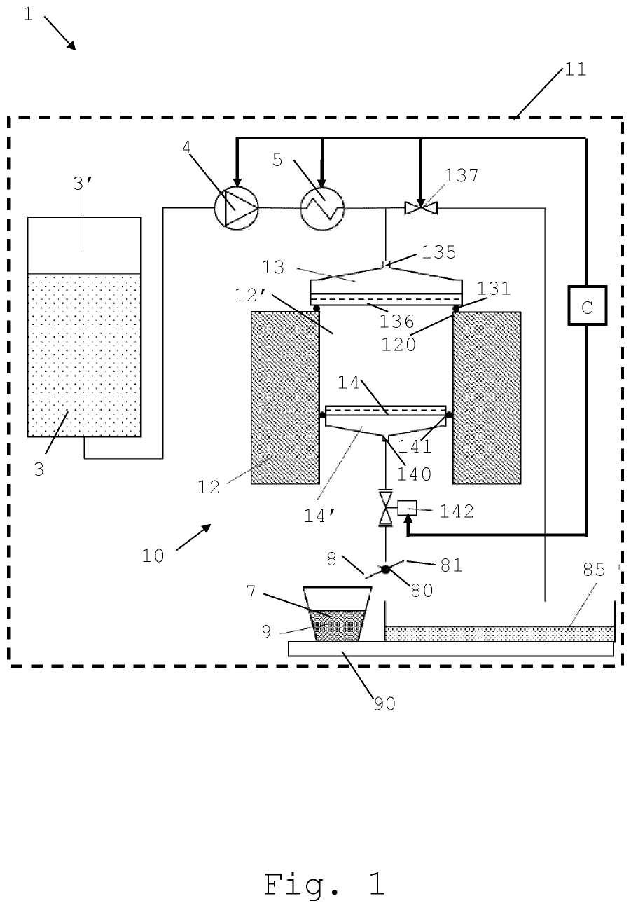

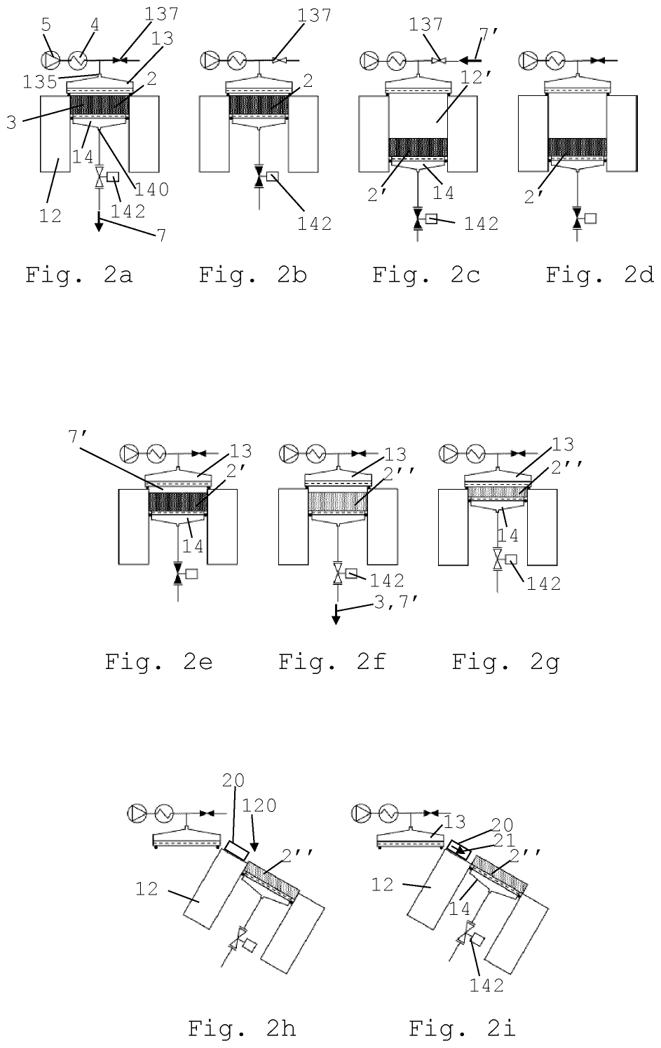

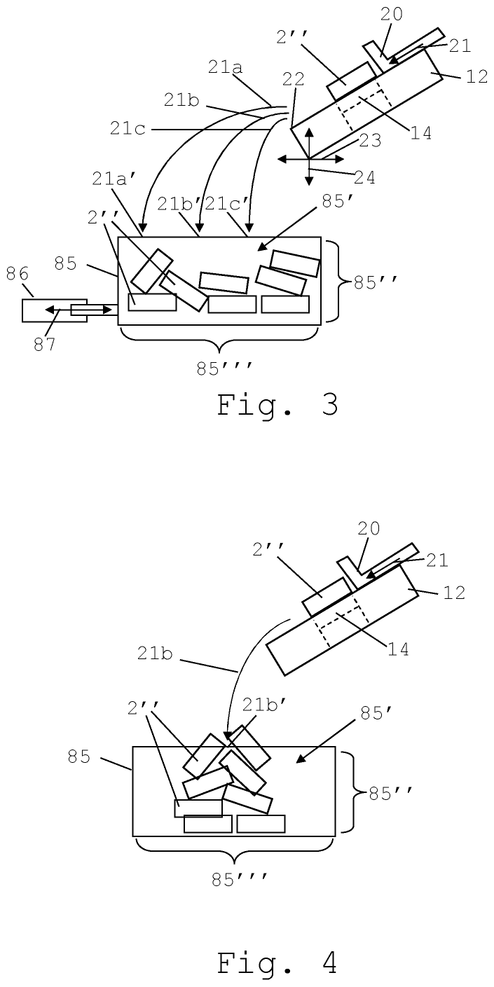

FIGS. 1 to 3 illustrate a non-limiting embodiment of a machine 1 and parts thereof (FIG. 1) as well as an operational sequence of such machine 1 according to the invention (FIGS. 2a to 2i and 3). FIG. 4, in which the same numeric references designate the same or similar features as in FIGS. 1 to 3, illustrates a comparative example.

Machine 1 illustrated in FIGS. 1 to 3 is configured for handling a flavouring ingredient 2 and preparing a beverage 7 therefrom and serving such beverage 7 via a dispensing outlet 8 to a consumer receptacle 9 e.g. placed on a support 90. Beverage 7 may be selected from coffee and tea and cacao or other beverages mentioned at the outset. Beverage 7 is prepared by mixing, e.g. infusing, ingredient 2 with water 3 from a water source 3′, e.g. a water tank and/or a connector to a water distribution network, for instance via a liquid driver 4 such as a pump and/or via a thermal conditioner 5 e.g. a water heater and/or a cooler.

Machine 1 has a mixing unit 10 that includes a support 11, such as a frame and/or housing, that is stationary during the handling of flavouring ingredient 2 and optionally during beverage preparation and/or beverage serving.

Mixing unit 10 has a seat 12, such as a seat 12 delimiting a substantially prismatic or cylindrical inner shape having a base that is for instance substantially circular or elliptic or ovoidal or polygonal, having an ingredient opening 120, such as an ingredient opening 120 configured to receive flavouring ingredient 2. Flavouring ingredient 2 may be received within or without capsule via the ingredient opening 120.

Mixing unit 10 comprises a closure part 13, for instance fixed to or integral with seat 12 or configured to close and open ingredient opening 120 of seat (12). Closure part 13 may form a lid on opening 120.

Mixing unit 10 includes a wall part 14 that is movable relatively to seat 12, such as a wall part 14 movable inside seat 12.

Wall part 14 may be formed by a piston 14′.

Wall part 14 can be movable by a wall part actuator, e.g. a motor.

Wall part 14 may be dimensioned to be in sliding contact along and over inner boundaries of the abovementioned inner shape of seat 12 at a seal 141 that is stationary relative to wall part 14 and that seals wall part 14 against the inner shape.

Mixing unit 10 includes a waste collector 85, for instance a waste reservoir that is user-removable for emptying and/or servicing e.g. cleaning. Collector 85 delimits a collecting chamber 85′ extending upright over a collecting height 85″ and horizontally over a collecting area 85′″. Collecting height 85″ may correspond to a distance in the range of 75 to 125%, e.g. 85 to 115% such as 95 to 105% of a vertical spacing between a bottom of chamber 85′ and a top end of waste collector 85. See FIG. 3.

Collector 85 may be associated with a detector for detecting a level of waste in collector chamber 85′ that has reached collecting height 85″, for instance a detector configured for preventing further preparation of beverage 7 until collector 85 has been emptied and/or generating an alarm signal that is user-perceivable.

Seat 12, closure part 13 and wall part 14 are directly or indirectly mounted to the support 11. For instance, wall part 14 is carried by seat 12 and/or the abovementioned wall part actuator is directly or indirectly fixed to seat 12. See FIGS. 1 to 2i.

Seat 12, closure part 13 and wall part 14 are relatively movable between:
at least one transfer configuration (FIGS. 2i and 3) for: supplying before beverage preparation flavouring ingredient 2 with or without an ingredient capsule into seat 12; and/or removing upon beverage preparation a waste consumable 2″ formed by waste flavouring ingredient 2″ and/or an ingredient capsule, for instance an unwrapped block of waste ingredient e.g. a cake; and
a mixing chamber configuration (FIG. 2a) in which seat 12 and closure part 13 and wall part 14 form a mixing chamber 12′ fluidically connected with water source 3′.

Mixing unit 10 is configured such that during beverage preparation, flavouring ingredient 2 is mixed with water 3 in mixing chamber 12′ to form beverage 7, e.g. by infusion and/or dissolution and/or dispersion, prior to serving such beverage 7 via dispensing outlet 8. (FIG. 2a)

Mixing unit 10 has a removal arrangement 20,22,86,C configured to direct, e.g. to push, after mixing, waste consumable 2″ into waste collector 85. See FIG. 3.

Seat 12 may be moved relatively to support 11 by a seat actuator, such as a motor, that is fixed to the support 11 or to seat 12. The seat actuator may be configured to relatively move support 11 and seat 12 via a transmission, such as a transmission comprising at least one of: gears, for instance wheels, e.g. toothed wheels, and/or worms; levers e.g. levers connected by a knuckle joint; belts such as toothed belts; and racks such as toothed racks. Seat actuator may be different to the abovementioned wall part actuator and/or different to a remover actuator.

Closure part 13 can be fixed relative to support 11 and seat 12 can be movable: against closure part 13 so as to close ingredient opening 120 by closure part 13; and away from the closure part 13 so as to open ingredient opening 120.

Closure part 13 may be configured to cover a rim of ingredient opening 120 and/or to remain substantially outside seat 12, when seat 12 is closed by closure part 13. Closure part 13 and seat 12 may be sealed off by a seal 131.

Wall part 14 and/or wall part actuator can be mounted to follow seat 12.

Wall part 14 may be configured to move after preparing beverage 7 waste consumable 2″ out of mixing chamber 12′ e.g. via ingredient opening 120.

Machine 1 may have a control unit C, such as a unit including at least one of a controller, processor, printed circuit board, memory, user-interface and power manager.

Mixing chamber 12′ may be associated with an inlet guide 135 and an outlet guide 140. Inlet guide 135 may be located in closure part 13 and outlet guide 140 may be located in wall part 14 or vice versa or both inlet and outlet guides may be located in the closure part or in the wall part.

Outlet guide 140 can be made of a flexible and/or rigid guide and/or associated with a filter 141.

Inlet guide 135 can be associated with a water distributor 136, e.g. a water shower, Removal arrangement 20,22,86,C and waste collector 85 are configured so as to direct successive removals of such waste consumables 2″ to different horizontal locations 21a′,21b′,21c′ of collecting area 85′″.

Removal arrangement 20,22,86,C and waste collector 85 are configured such as to promote a substantially uniform filling of collecting chamber 85′ over its collecting height 85″ by waste consumables 2″ of the successive removals. Removal arrangement 20,22,86,C and waste collector 85 may be configured to form an accumulation of waste consumables 2″ of successive removals in collecting chamber 85′ to reach collecting height 85″ such that a ratio of residual collecting volume free of waste consumable 2″ between the accumulation and collecting height 85″ over a total collecting volume of collecting chamber 85′ is below 20%, for instance below 15%, for example below 10%, e.g. below 5%, of the total collecting volume of chamber 85′.

Mixing unit 10 may include a waste remover 20 configured to remove waste consumable 2″ from ingredient opening 120 upon beverage preparation and optionally after waste consumable 2″ having been pushed out of opening 120 by a corresponding relative movement of wall part 14 and seat 12

Remover 20 can have a drawer-type configuration for being deployed and retracted over ingredient opening 120 in the transfer configuration.

Remover 20 may have a remover actuator, e.g. a motor, to relatively move 21 remover 20 and seat 12 during removal of waste consumable 2″. Remover actuator may be connected to at least one of remover 20 and seat 12 by a transmission, such as a transmission comprising at least one of: gears, for instance wheels, e.g. toothed wheels, and/or worms; and racks e.g. toothed racks.

The remover actuator may be fixed to support 11 or to seat 12. The remover actuator can be different to the abovementioned seat actuator and/or different to the abovementioned wall part actuator.

Waste remover 20 may be configured to direct such waste consumables 2″ to collecting area 85′″ at different velocities 21a,21b,21c, for instance at a number of different velocities in the range of 2 to 10, such as 3 to 5.

Removal arrangement 20,22,86,C may include a removal edge 22, such as a removal edge 22 located above collecting chamber 85′ and/or formed by seat 12, from which waste consumables 2″ are directed to collecting chamber 85′. Removal edge 22 and collecting chamber 85′ may be relatively movable 23,24, for instance horizontally 23 and/or vertically 24, to direct waste consumables 2″ to different horizontal locations 21a′,21b′,21c′ of the collecting area 85′″.

During the removal different operations may be contemplated:
collecting chamber 85′ may be stationary and removal edge 22 may be movable relative to support 11; or
collecting chamber 85′ may be movable and removal edge 22 may be stationary relative to support 11; or
collecting chamber 85′ and removal edge 22 may be movable relative to each other and both movable relative to support 11.

Removal arrangement 20,22,86,C may include a collector actuator 86 configured to move 87 back and forth, e.g. repeatedly back and forth, waste collector 85 relative to the support 11, for instance to vibrate waste collector 85. Collector actuator 86 may be activated permanently, periodically or intermittently, e.g. each time upon reception of such waste consumable 2″ by collector 85.

By providing the above configuration, as illustrated in FIG. 3, the volume of collecting chamber 85′ can be well filled by accumulated waste consumables 2″. Conversely prior art configurations, of the type disclosed in FIG. 4, that are not provided with the above removal arrangement and direct 21b waste consumables always to the same horizontal location 21b′, tend to lead to generally pyramidal or conical or domical accumulations of waste consumables 2″ over the bottom of the collecting chamber 85′ leaving significant lateral spaces in the collecting chamber 85′ unfilled. Thus, prior art configurations tend to require more frequent emptying of the collecting chamber 85′ improperly filled with accumulated waste consumables 2″.

Mixing unit 10 may be configured to provide compressed gas 7′, such as air, in mixing chamber 12′ containing waste consumable 2′, e.g. infusible flavouring ingredient 2′ upon infusion, and to evacuate at least part of water 3 contained in mixing chamber 12′ with such compressed gas 7′ by releasing gas 7′ from mixing chamber 12′ before the removal of waste consumable 2″. See FIGS. 2c to 2f.

Mixing unit 10 may be configured to repeat once or several times the providing of compressed gas 7′ into mixing chamber 12′ and evacuating of part of water 3 with such compressed gas 7′ from mixing chamber 12′.

Mixing unit 10 can be configured to inhibit or prevent an urging of waste consumable 2′ against both closure part 13 and wall part 14 between the providing of compressed gas 7′ into and its release from mixing chamber 12′. See FIGS. 2e and 2f, in particular the gap between ingredient 2′,2″ and closure part 13.

Mixing unit 10 may be configured to inhibit or prevent a removal of water 3 contained in mixing chamber 12′ from waste consumable 2′ between the providing of compressed gas 7′ into and its release from mixing chamber 12′. See FIGS. 2b to 2e.

Dispensing outlet 8 can be associated with a directing device 80 configured to direct beverage 7 from the abovementioned outlet guide 140 to consumer receptacle 9 and residual liquid to waste collector 85, e.g. via a draining edge 81 of directing device 80. Directing device 80 may be configured to direct at least part of water 3 evacuated from mixing chamber 12′ by releasing compressed gas 7′ to waste collector 85 or to consumer receptacle 9. See FIG. 1.

Mixing unit 10 may be configured to release compressed gas 7′ via the abovementioned outlet guide 140 so as to evacuate residual beverage 7 from outlet guide 140. Outlet guide 140 can be fluidically connected with an outlet valve 142 for closing and opening outlet guide 142, e.g. a solenoid valve and/or a pinch valve. See FIG. 2f. Outlet valve 142 may be closed when compressed gas 7′ is contained in mixing chamber 12′ and opened to release via outlet guide 140 compressed gas with at least part of water 3 contained in mixing chamber 12′. See FIGS. 2c to 2f.

Mixing unit 10 may be configured such that after releasing compressed gas 7′ wall part 14 is moved against waste consumable 2′, e.g. infusible flavouring ingredient 2′ upon infusion, in mixing chamber 12′ so as to compact waste consumable 2″ in mixing chamber 12′, optionally without further evacuating part of water 3 possibly still contained in mixing chamber 12′. Waste consumable 2′,2″ may be compacted in mixing chamber 12′: between and against both closure part 13 and wall part 14; and/or to undergo a volume reduction in the range of 5 to 75% such as 10 to 50%, e.g. 2 to 40%. See FIG. 2g.

Mixing unit 10 can be configured to evacuate after compressed gas 7′ is released, waste consumable 2″ towards waste collector 85.

Waste consumable 2″ may be moved by wall part 14 out of mixing chamber 12′ e.g. via ingredient opening 120. See FIGS. 2h to 2i and 3.

Ingredient opening 120 may be tilted, e.g. by relatively moving seat 12 and closure part 13 and wall part 14 from the mixing chamber configuration to the transfer configuration, to facilitate evacuation of waste consumable 2″. Ingredient opening 120 may be tilted relative to a horizontal direction by an angle in the range of 5 to 80 deg., such as of 15 to 75 deg., for instance of 30 to 60 deg., e.g. of 40 to 50 deg.

Ingredient opening 120 can be associated with remover 20 configured to remove in removal direction 21 waste consumable 2″ from opening 120 towards waste collector 85.

Mixing unit 10 can have a gas device 14,137 for providing compressed gas 7′ into mixing chamber 12′. The device may include at least one of: a gas pump; a compressed gas tank; and a or the abovementioned valve as a gas valve 137.

The device may have gas pump that is fluidically connected to mixing chamber 12′ via a dedicated inlet of mixing chamber 12′ or via inlet guide 135 and/or outlet guide 140. For instance, the gas pump is controlled by a or the abovementioned control unit C.

The device may include the compressed gas tank that is fluidically connected through a or the abovementioned gas valve to mixing chamber 12′ via a dedicated inlet of mixing chamber 12′ or via inlet guide 135 and/or outlet guide 140. For instance, the gas valve is controlled by a or the abovementioned control unit C.

Gas device 14,137 may include gas valve 137 that fluidically connects mixing chamber 12′ and a gas source, such as ambient air e.g. at ambient pressure, via a dedicated inlet of mixing chamber 12′ or via inlet guide 135 and/or outlet guide 140. Device 14,137 may further include wall part 14 that is movable inside seat 12. For instance, gas valve 137 and wall part 14 are controlled by a or the abovementioned control unit C. Wall part 14 may be movable inside seat 12 to: expand mixing chamber 12′ thereby drawing gas 7′ via open gas valve 137 into mixing chamber 12′; and collapse mixing chamber 12′ thereby compressing gas 7′ in mixing chamber 12′ when gas valve 137 is closed. See FIGS. 2b to 2e.

Mixing unit 10 can be configured to provide compressed gas 7′ in mixing chamber 12′ at a maximum pressure above ambient pressure of 0.5 bar, such as in the range of 1 to 30 bar, for instance 2 to 20 bar, e.g. 3 to 10 bar, for example 4 to 7 bar, above ambient pressure. See FIG. 2e.

Mixing unit 10 can be configured to release compressed gas 7′ from mixing chamber 12′ to evacuate at least part of water 3 from a or the abovementioned maximum pressure of gas 7′ in mixing chamber 12′ to a pressure of 0.1 bar above ambient pressure within a period of time of less than 3 sec., such as in the range of 0.001 to 2 sec., for instance in the range of 0.01 to 1 sec., for example in the range of 0.1 to 0.5 sec., e.g. in the range of 0.2 to 0.3 sec. See FIG. 2f.

After an introduction into the seat's ingredient opening 120 in the transfer configuration of at least one solid portion of a self-supporting agglomerate of flavouring ingredient 2, such as (a) capsule-free portion(s) or (a) portion(s) within (a) capsule(s) removed by such machine 1 prior to a passage of such portion(s) through ingredient opening 120, and subsequent relative movement from the transfer configuration into the mixing chamber configuration and prior to serving beverage 7 via dispensing outlet 8, the abovementioned control unit C can be configured to control a preconditioning of flavouring ingredient 2 by: a portion break-up relative movement of seat 12 and closure part 13 and wall part 14, such as by controlling one or more actuators 16,17, e.g. motors, associated therewith; and/or a portion loosening supply of water 3 from a or the abovementioned water source 3′ into mixing chamber 12′, such as by controlling a or the abovementioned liquid driver 4 and optionally a or the abovementioned thermal conditioner 5.

Flavouring ingredient 2 can be introduced into chamber's opening 120 as one or more solid portions, each portion having a rollable shape, e.g. a substantially spherical or ellipsoidal or cylindrical shape or a combination of parts of such shapes, with: a maximum dimension in the range of 15 to 35 mm such as 17.5 to 30 mm e.g. 20 to 27 mm; and/or a maximum dimension in the range of 10 to 90%, for instance 25 to 75% such as 40 to 65% e.g. 51 to 60%, of a maximum dimension of the base of the seat's inner shape.

Control unit C may be configured to control via the abovementioned at least one actuator the break-up relative movement between wall part 14 and closure part 13 so as to exercise a compression force F onto solid portion(s) between closure and wall parts 13,14 to break-up solid portion(s) 2.

For instance, the agglomerate flavouring ingredient is selected from ground coffee and tea and cacao, such as 4 to 12 g ground coffee e.g. 5 to 9 g ground coffee.

Control unit C and the abovementioned at least one actuator can be configured such that compression force F is of at least 20 N, such as at least 30 N, for instance at least 40 N. Compression force F can be of at most 200 N, such as at most 175 N, for instance at most 150 N, e.g. at most 125 N.

Control unit C may be configured to control the break-up relative movement between wall part 14 and closure part 13 such that closure and wall parts 13,14 are relatively moved to one another between a break-up starting spacing at which compression force F is generated and a mixing spacing at which flavouring ingredient 2 is mixed with water 3. The mixing spacing and the break-up starting spacing may have a ratio in the range of 0.1 to 0.8 such as 0.2 to 0.4.

Machine 1 can have a sensor arrangement connected to control unit C for sensing the break-up starting spacing, control unit C being configured to determine the mixing spacing from the sensed break-up starting spacing and/or from monitoring an evolution of a required compression force F when closure and wall parts 13,14 are relatively moved to one another between the break-up starting spacing and the mixing spacing.

The sensor arrangement can be configured to determine at least one of: a power consumption of at least one actuator e.g. by measuring an electric current and/or voltage consumed by such actuator(s) 17; and a volume and/or weight and/or number of portions supplied into ingredient opening 120 for a serving of beverage 7 via dispensing outlet 8.

Control unit C, to control the preconditioning of flavouring ingredient 2, may control the abovementioned liquid driver 4 and optionally the abovementioned thermal conditioner 5 e.g. for thermal conditioning to a temperature corresponding substantially to a water temperature during beverage preparation and serving of beverage 7 via dispensing outlet 8 (e.g. a water conditioning temperature that is within 3, 5 or 10° C. of a beverage preparation temperature or a beverage serving temperature), to supply the abovementioned portion loosening supply of water 3 into mixing chamber 12′ and then to interrupt the supply of water 3 for a period of time, such as for 1 to 120 sec. for instance 5 to 60 sec. e.g. 10 to 30 sec. and/or at a pressure in mixing chamber 12′ that is substantially constant, prior to serving beverage 7.

Control unit C can be configured to control the supply into mixing chamber 12′ of the abovementioned portion loosening supply of water 3:
after and/or before carrying out the abovementioned portion break-up relative movement of seat 12 and closure part 13 and wall part 14; and/or
in a volume that is in a range of 3 to 85%, such as 5 to 50%, e.g. 10 to 25%, of a total volume of mixing chamber 12′ at a spacing of closure and wall parts 13,14 when the abovementioned beverage 7 is prepared and served via dispensing outlet 8; and/or
at a or the abovementioned pressure in mixing chamber 12′ that is in a range of 0.1 to 30 bar above ambient pressure, such as 0.5 to 25 bar above ambient pressure, for instance 1 to 20 bar above ambient pressure, e.g. 2.5 to 16 bar or 4 to 13 bar above ambient pressure; and/or
while closing the abovementioned outlet guide 140 with an outlet valve 142, such as: a resilient valve, e.g. a check-valve; and/or a valve controlled by control unit C, e.g. a solenoid valve and/or a pinch valve.

During operation of machine 1, flavouring ingredient 2, within or without a capsule, can be supplied into seat 12 in the transfer configuration. After seat 12 is brought into the mixing chamber configuration, ingredient 2 may be mixed with water 3 in mixing chamber 12′ to form beverage 7 that may then be served via dispensing outlet 8. After serving beverage 7, at least part of water 3 contained in mixing chamber 12′ may optionally be evacuated by compressed gas 7′ to at least partly dry waste consumable 2′. Waste consumable 2″ may be removed by removal arrangement 20,22,86,C to waste collector 85, whereby waste consumables 2″ of successive removals are directed to different horizontal locations 21a′,21b′,21c′ of collecting area 85′″.

1. A machine for handling a flavouring ingredient and preparing a beverage therefrom and serving said beverage via a dispensing outlet to a consumer receptacle, said ingredient with water from a water source that comprises:
a support, such as a frame and/or housing, that is stationary during said handling of said flavouring ingredient and optionally during beverage preparation and/or beverage serving;
a seat, such as a seat delimiting a substantially prismatic or cylindrical inner shape having a base having an ingredient opening;
a closure part, for instance fixed to or integral with the seat or configured to close and open the ingredient opening of the seat, such as a closure part configured to form a lid on the opening;
a wall part that is movable relatively to the seat; and
a waste collector, the collector delimiting a collecting chamber extending upright over a collecting height and horizontally over a collecting area, the collecting height corresponding for instance to a distance in the range of 75 to 125% of a vertical spacing between a bottom of the chamber and a top end of the waste collector, a detector configured for preventing further preparation of beverage until the collector has been emptied and/or generating an alarm signal that is user-perceivable,
the seat, the closure part and the wall part being:
directly or indirectly mounted to the support; and
relatively movable between:
at least one transfer configuration for:
supplying before beverage preparation said flavouring ingredient with or without an ingredient capsule into the seat; and/or
removing upon beverage preparation a waste consumable formed by waste flavouring ingredient and/or an ingredient capsule;
and
a mixing chamber configuration in which the seat and the closure part and the wall part form a mixing chamber fluidically connected with the water source,
the mixing unit being configured such that during beverage preparation, said flavouring ingredient is mixed with said water in the mixing chamber to form said beverage, e.g. by infusion and/or dissolution and/or dispersion, prior to serving thereof via the dispensing outlet,
the mixing unit comprising a removal arrangement configured to direct after mixing, said waste consumable into the waste collector,
the removal arrangement and the waste collector are configured so as to direct successive removals of such waste consumables to different horizontal locations of the collecting area.

2. The machine of claim 1, wherein the removal arrangement and the waste collector are configured such as to promote a substantially uniform filling of the collecting chamber over its collecting height by said waste consumables of the successive removals.

3. The machine of claim 1, wherein the mixing unit comprises a waste remover configured to remove said waste consumable from the ingredient opening upon beverage preparation; and
a remover actuator to relatively move the remover and the seat during removal of said waste consumable, the remover actuator being connected to at least one of the remover and the seat by a transmission.

4. The machine of claim 3, wherein the waste remover is configured to direct such waste consumables to the collecting area at different velocities.

5. The machine of claim 1, wherein the removal arrangement comprises a removal edge.

6. The machine of claim 1, wherein the removal arrangement comprises a collector actuator configured to move back and forth, the waste collector relative to the support.

7. The machine of claim 1, wherein the mixing unit is configured to provide compressed gas, in the mixing chamber containing said waste consumable, after the serving of said beverage and to evacuate said at least part of said water contained in the mixing chamber with said compressed gas by releasing the gas from the mixing chamber before the removal of said waste consumable.

8. The machine of claim 7, wherein the mixing unit is configured:
to release the compressed gas via said outlet guide so as to evacuate residual beverage from said outlet guide; and
such that after releasing said compressed gas the wall part is moved against said waste consumable in the mixing chamber so as to compact said waste consumable in the mixing chamber.

9. The machine of claim 1, wherein, after an introduction into the seat's ingredient opening in the transfer configuration of at least one solid portion of a self-supporting agglomerate of said flavouring ingredient and subsequent relative movement from the transfer configuration into the mixing chamber configuration and prior to serving said beverage via the dispensing outlet,
said control unit is configured to control a preconditioning of the flavouring ingredient by:
a portion break-up relative movement of the seat and the closure part and the wall part; and
a portion loosening supply of water from said water source into the mixing chamber, such as by controlling a or said liquid driver.

10. The machine of claim 9, wherein the control unit is configured to control via said at least one actuator said break-up relative movement between the wall part and the closure part so as to exercise a compression force onto the solid portion(s) between the closure and wall parts to break-up the solid portion(s).

11. The machine of claim 9, wherein the control unit, to control the preconditioning of the flavouring ingredient, controls said liquid driver to supply said portion loosening supply of water into the mixing chamber and then to interrupt the supply of water for a period of time.

12. A combination of a machine for handling a flavouring ingredient and preparing a beverage therefrom and serving said beverage via a dispensing outlet to a consumer receptacle, said ingredient with water from a water source that comprises:
a support, such as a frame and/or housing, that is stationary during said handling of said flavouring ingredient and optionally during beverage preparation and/or beverage serving;
a seat, such as a seat delimiting a substantially prismatic or cylindrical inner shape having a base having an ingredient opening;
a closure part, for instance fixed to or integral with the seat or configured to close and open the ingredient opening of the seat, such as a closure part configured to form a lid on the opening;
a wall part that is movable relatively to the seat; and
a waste collector, the collector delimiting a collecting chamber extending upright over a collecting height and horizontally over a collecting area, the collecting height corresponding for instance to a distance in the range of 75 to 125% of a vertical spacing between a bottom of the chamber and a top end of the waste collector, a detector configured for preventing further preparation of beverage until the collector has been emptied and/or generating an alarm signal that is user-perceivable,
the seat, the closure part and the wall part being:
directly or indirectly mounted to the support; and
relatively movable between:
at least one transfer configuration for:
supplying before beverage preparation said flavouring ingredient with or without an ingredient capsule into the seat; and/or
removing upon beverage preparation a waste consumable formed by waste flavouring ingredient and/or an ingredient capsule;
and
a mixing chamber configuration in which the seat and the closure part and the wall part form a mixing chamber fluidically connected with the water source,
the mixing unit being configured such that during beverage preparation, said flavouring ingredient is mixed with said water in the mixing chamber to form said beverage, e.g. by infusion and/or dissolution and/or dispersion, prior to serving thereof via the dispensing outlet,
the mixing unit comprising a removal arrangement configured to direct after mixing, said waste consumable into the waste collector,
the removal arrangement and the waste collector are configured so as to direct successive removals of such waste consumables to different horizontal locations of the collecting area and said flavouring ingredient for preparing said beverage in the machine.

13-14. (canceled)

15. The machine of claim 1, wherein said flavouring ingredient is shaped as at least one solid portion of a self-supporting agglomerate of such flavouring ingredient.
